(19) United States
(12) Patent Application Publication
(10) Pub. No.: US 2026/0241561 A1
(43) Pub. Date: Aug. 20, 2026

(54) NEURAL CONFIGURATION DISTANCE FUNCTION FOR CONTINUUM ROBOT CONTROL

(71) Applicant: Toyota Motor Engineering & Manufacturing North America, Inc., Plano, TX (US)

(72) Inventors: Kehan Long, Los Angeles, CA (US); Georgios Fainekos, Novi, MI (US); Bardh Hoxha, Canton, MI (US); Hideki Okamoto, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/057,472

(22) Filed: Feb. 19, 2025

(51) Int. Cl. B25J 9/16; B25J 9/06

(52) U.S. Cl. CPC B25J 9/1666; B25J 9/065; B25J 9/161; B25J 9/1625; B25J 9/163; B25J 9/1671

(57) ABSTRACT

A computer-implemented method of planning motion of a continuum robot in a dynamic environment is provided. The method includes training a neural configuration Euclidean distance function (N-CEDF) using training data and a neural network for learning a geometry of each link of the continuum robot and determining a distance field for each link providing a learned N-CEDF. The learned (N-CEDF) is integrated into a Sampling-Based Path or Mothion Planning algorithm (SBMP) to generate an N-CEDF SBMP framework. The N-CEDF SBMP framework is employed for motion planning of the continuum robot for determining a planned trajectory in the dynamic environment.

### TECHNICAL FIELD

The present specification generally relates to methods for modeling the shape of a continuum robot as a Neural Configuration Euclidean Distance Function.

### BACKGROUND

Continuum robots are characterized by flexible continuously curving structures. They are of significant practical interest due to their potential applications in minimally invasive surgery, search and rescue operations, and confined space exploration. Unlike traditional rigid link robots, continuum robots offer superior adaptability and maneuverability in complex and cluttered environments. However, their infinite degrees of freedom and inherent compliance pose challenges for model identification, shape modeling, and motion planning.

Recent advancements in continuum robot research have focused on designing reliable real robots, deriving accurate robot models, and developing efficient planning and control strategies. While various modeling approaches exist, the piecewise constant curvature (PCC) model has emerged as a popular approach for capturing simplified kinematics for continuum robots, striking a balance between computational efficiency and accuracy. Building upon this foundation, researchers have explored various motion planning and control methodologies, including rapidly exploring random trees (RRT) and its variants RRT*, model predictive control (MPC), and neural networks. However, these approaches usually abstract the robot shape as a point cloud or collection of spheres, leading to either inaccurate collision evaluation and suboptimal planning or computational inefficiency. Creating a precise and computationally efficient representation of the continuum robot shape is a central challenge for real-time motion planning and control, especially in cluttered and dynamic environments with point cloud data observations.

### SUMMARY

In one embodiment, a computer-implemented method of planning motion of a continuum robot in a dynamic environment is provided. The method includes training a neural configuration Euclidean distance function (N-CEDF) using training data and a neural network for learning a geometry of each link of the continuum robot and determining a distance field for each link providing a learned N-CEDF. The learned (N-CEDF) is integrated into a Sampling-Based Path or Mothion Planning algorithm (SBMP) to generate an N-CEDF SBMP framework. The N-CEDF SBMP framework is employed for motion planning of the continuum robot for determining a planned trajectory in the dynamic environment.

In another embodiment, a computer-implemented method of planning motion of a continuum robot in a dynamic environment is provided. The method includes modeling a shape of the continuum robot in a dynamic environment using a neural configuration Euclidean distance function (N-CEDF), where the N-CEDF encoding a geometry of each link of the continuum robot using a neural network. The neural configuration Euclidean distance function (N-CEDF) is integrated into a Sampling-Based Path or Mothion Planning algorithm (SBMP) saved in memory of the computer to generate an N-CEDF SBMP framework. A planned trajectory is determined for the continuum robot in the dynamic environment using the N-CEDF SBMP framework.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a continuum robot link with parameters: cable lengths l₁, l₂, l₃, backbone length L, bending angle θ, and bending plane angle 4, according to one or more embodiments shown and described herein;

FIG. 1B schematically depicts a 4-link continuum robot with a specific configuration in a dynamic environment with spherical obstacles and an end-effector goal (star), according to one or more embodiments shown and described herein;

FIG. 2A depicts a visualization of the N-CEDF for a continuum robot link in one configuration, according to one or more embodiments shown and described herein;

FIG. 2B depicts another visualization of the N-CEDF for the continuum robot link in another configuration, according to one or more embodiments shown and described herein;

FIG. 3 shows three terms of a cost function that plays a role in guiding the robot behavior, according to one or more embodiments, shown and described herein;

FIG. 4 is a graph of end-effector distance to goal and distances from robot to obstacles, according to one or more embodiments shown and described herein;

FIG. 5A schematically depicts safe navigation of a 4-link continuum robot at time step 20, where the star denotes the goal, the box shapes denote the static obstacles, and the spheres denote the dynamic obstacles and the MPPI planned trajectory of its end-effector is shown in dots, according to one or more embodiments shown and described herein;

FIG. 5B schematically depicts the 4-link continuum robot of FIG. 5A at time step 52, according to one or more embodiments shown and described herein;

FIG. 5C schematically depicts the 4-link continuum robot of FIG. 5A at time step 104, according to one or more embodiments shown and described herein;

FIG. 5D schematically depicts the 4-link continuum robot of FIG. 5A at time step 158, according to one or more embodiments shown and described herein;

FIG. 6A schematically depicts a 5-link continuum robot at time step 16, according to one or more embodiments shown and described herein;

FIG. 6B schematically depicts the 5-link continuum robot of FIG. 6A at time step 82, according to one or more embodiments shown and described herein;

FIG. 7A schematically depicts a 7-link continuum robot at time step 14, according to one or more embodiments shown and described herein; and

FIG. 7B schematically depicts the 7-link continuum robot of FIG. 7A at time step 43, according to one or more embodiments shown and described herein.

### DETAILED DESCRIPTION

The present disclosure is directed to a Neural Configuration Euclidean Distance Function (N-CEDF) for modeling continuum robot shapes, inspired by recent success in learning-based approaches for object and rigid robot shape modeling. An N-CEDF exploits the kinematic structure of a continuum robot to learn a distance function representation for each robot segment independently. This significantly reduces the problem dimensionality and enhances the shape prediction accuracy. During inference, the complete robot shape is synthesized by combining linkwise representations through the forward kinematics chain.

The advantages of the N-CEDF representation by integrating it into a Sampling-Based Path or Mothion Planning algorithm (SBMP), such as a Model Predictive Path Integral (MPPI) controller are demonstrated herein, see G. Williams, P. Drews, B. Goldfain, J. M. Rehg, and E. A. Theodorou, “Aggressive driving with model predictive path integral control,” in 2016 IEEE International Conference on Robotics and Automation (ICRA), pp. 1433-1440, IEEE, 2016 incorporated by reference herein. This can enable safe and efficient motion planning for continuum robots relying on point cloud observations of dynamic and cluttered environments.

Contribution of the present disclosure include:
Introduction of a safety-aware neural configuration Euclidean distance function (N-CEDF) for modeling the shape of continuum robots. The N-CEDF is trained with a loss function penalizing distance-to-obstacle overestimation to enhance safety in motion planning.
Combining the learned N-CEDF for each link into a single shape model through the robot's kinematic chain, enabling efficient, environment-agnostic distance queries to points in the workspace.
Integrating the learned N-CEDF into the MPPI frame-work for safe motion planning in dynamic and cluttered environments. The proposed approach is validated through extensive simulations in several scenarios.

### Problem Formation

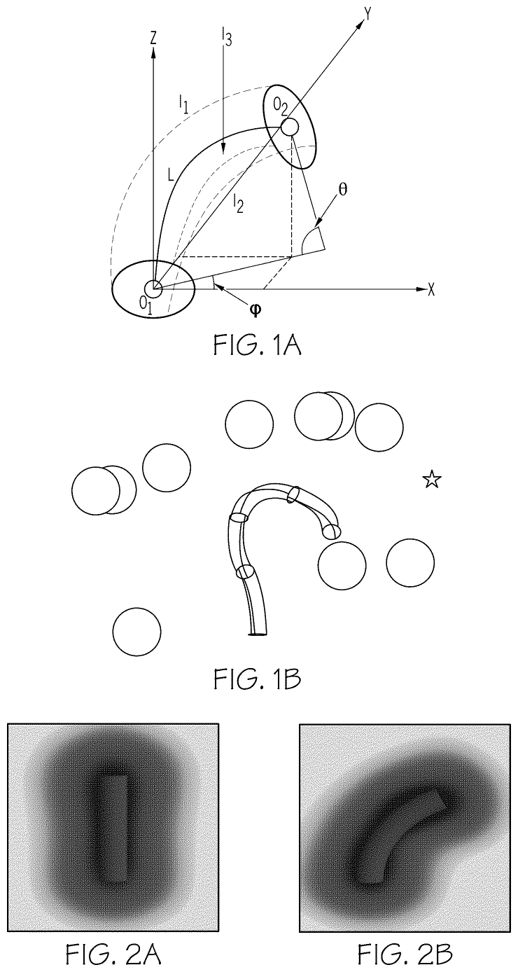

A 3D continuum robot is modeled as a series of M deformable links. See B. H. Meng, I. S. Godage, and I. Kanj, “RRT*-based path planning for continuum arms,” IEEE Robotics and Automation Letters, vol. 7, no. 3, pp. 6830-6837, 2022, P. Luo, S. Yao, Y. Yue, J. Wang, H. Yan, and M. Q.-H. Meng, “Efficient RRT*-based safety-constrained motion planning for continuum robots in dynamic environments,” in IEEE International Conference on Robotics and Automation (ICRA), pp. 9328-9334, 2024, and J. Deng, B. H. Meng, I. Kanj, and I. S. Godage, “Near-optimal smooth path planning for multisection continuum arms,” in 2019 2nd IEEE International Conference on Soft Robotics (RoboSoft), pp. 416-421, 2019, which are all incorporated herein by reference. Each link consists of a flexible, inextensible backbone of length Lᵢ driven by three cables equispaced at intervals of 2π/3 radians around the backbone (FIG. 1A). While cables are described, other suitable drives may be used, such as a pneumatic actuator. By controlling the cable lengths l_{i,j} where i∈{1, . . . , M} and j∈{1, 2, 3}, the spatial configuration of each link and the entire robot body can be actively manipulated. lₘᵢₙ and lₘₐₓ are defined as the lower and upper bounds of the cable length, respectively, such that lₘᵢₙ≤lᵢⱼ≤lₘₐₓ holds. With the constant curvature model, the lengths of the three drive cables are constrained by the relationship

$$\frac{1}{3} {\sum }_{j = 1}^{3} {l}_{i \cdot j} = {L}_{i}$$

for all i.

According to the PCC model, the bending of each link can be described by three curve parameters: the radius ρᵢ of the circular arc of the backbone, the bending angle θi∈[0, π], and the bending plane angle φᵢ∈[−π, π]. These parameters can be derived from the cable lengths as follows:

$${θ}_{1} = \sqrt[2]{\frac{{l}_{i , 1}^{2} + {l}_{i , 2}^{2} + {l}_{i , 3}^{2} - {l}_{i , 1} {l}_{i , 2} - {l}_{i , 1} {l}_{i , 3} - {l}_{i , 2} {l}_{i , 3}}{3 {r}_{i}}} ,$$

$${φ}_{i} = arctan 2 ( \sqrt{3} ( {l}_{i , 2} - {l}_{i , 3} ) , {l}_{i , 2} + {l}_{i , 3} - 2 {l}_{i , 1} ) ,$$

where rᵢ is the radius of the link, and

$${ρ}_{i} = \frac{{L}_{i}}{{θ}_{i}} .$$

The configuration of the i-th link is qᵢ=[θᵢ, φᵢ]^{T}∈[0,π]×[−π,π].

Consequently, the overall configuration of the 3D continuum robot with M links can be represented as:

$$q = {[ {q}_{1}^{T} , … , {q}_{M}^{T} ]}^{T} ∈ {ℝ}^{2 M} .$$

FIG. 1B shows an example of a continuum robot with four links, each having different bending angles and bending plane angles, representing a specific robot configuration.

Given a configuration q, the robot body can be denoted by a set-valued function B(q)⊂ [symbol] , and its surface by ∂B(q). The pose of the base center of the i-th link with respect to its previous link's base frame is given by Ti(q). The shape of each link in its local frame is represented as Bᵢ(qᵢ). The entire robot body can be described as:

$$\overline{B} ( q ) = {⋃}_{i = 1}^{M} ( {\prod }_{i = 1}^{i} {T}_{j} ( q ) ) {\overline{B}}_{i} ( {q}_{i} ) ,$$

where B̅, B̅ᵢ⊂ [symbol] ×{1} represent the homogeneous coordinates,

$${\prod }_{j = 1}^{i} {T}_{j} ( q )$$

represents the transformation from the global frame to the i-th link's base frame. The end-effector pose is denoted as Tₑₑ(q)∈SE(3).

$$Let {x}^{k} = {[ {l}_{1 , 1}^{k} + {l}_{1 , 2}^{k} + {l}_{1 , 3}^{k} , … , {l}_{M , 1}^{k} + {l}_{M , 2}^{k} + {l}_{M , 3}^{k} ]}^{T} ∈ {ℝ}^{3 M}$$

denote the vector containing the lengths of all drive cables at time step k. The discrete-time robot dynamics are:

$${x}^{k + 1} = {x}^{k} + {u}^{k} {τ}^{k} ,$$

where u^{k}∈ [symbol] is the control input, and τ^{k} is the sampling time. The relation between q^{k} and x^{k} is given above.

We consider an environment containing both static and dynamic obstacles. Let O^{k}⊂ [symbol] denote the closed obstacle set at time step k, and F^{k} [symbol] \O^{k} represent the free space, which is an open set.

Problem 1. Consider a continuum robot, modeled as a series of M links, with initial configuration q₀ and dynamics as in x^{k+1}=x^{k}+u^{k}τ^{k}. Design a control policy that efficiently drives the robot's end-effector Tₑₑ(q) to a desired goal pose T_{G}∈SE(3), while ensuring that the robot remains within the free space F^{k} of a dynamic environment, i.e., B(q^{k})⊂F^{k}, ∀k≥0.

### Neural Configuration Euclidean Distance Function

To facilitate safe control of the continuum robot, the robot's body B(q) should be represented accurately. However, representing this set-valued function can be challenging for continuum robots due to their complex and deformable geometry. To address this challenge, an approach is proposed that approximates the shape of a continuum robot as a collection of Configuration Euclidean Distance Functions (CEDFs), with each CEDF modeling the shape Bi(qi) of each link. The contribution described herein lies in extending the approach to capture the unique shape and deformation characteristics of continuum robots. By representing the robot's shape as an N-CEDF, the spatial relationship between the robot and the environment can be efficiently computed, enabling safe and effective navigation in dynamic environments.

### Configuration EDF for Continuum Robot

The shape of each link of a continuum robot can be approximated using a CEDF. A distance function, in general, measures the distance from a point to the surface of a set. For a continuum robot, where the shape of each link deforms with the configuration qᵢ, a CEDF captures these changes dynamically. The distance function for the i-th link, Γ(p, qᵢ): [symbol] × [symbol] → [symbol] ′ is defined as:

$${Γ}_{i} ( p , q ) = d ( p , \partial {B}_{i} ( {q}_{i} ) ) := \begin{matrix}inf \\ {p}^{′} ∈ \partial {B}_{i} {q}_{i}\end{matrix} {‖ p - {p}^{′} ‖}_{2} .$$

An overall CEDF for the entire continuum robot. The CEDF from a point p in the global frame to the i-th link is given by:

$${Γ}_{i}^{b} ( p , q ) = {Γ}_{i} ( {( {\prod }_{j = 1}^{i} {T}_{j} ( q ) )}^{- 1} \overline{p} , {q}_{i} ) ,$$

where p̅=[p^{T}, 1]^{T} represents the point p in homogeneous coordinates. Finally, the overall CEDF for the robot body is computed as the minimum of all link CEDFS:

$$Γ ( p , q ) = \begin{matrix}min \\ i = 1 , … , M\end{matrix} {Γ}_{i}^{b} ( p , {q}_{i} ) .$$

### Data Preparation and Loss Function

To accurately model the CEDF Γ(p, q), the CEDF of each link is represented Γᵢ(p, q) using a neural network, \hat{Γ}ᵢ(p, qᵢ; θᵢ), parameterized by θᵢ. The combined learned N-CEDF for the entire robot is denoted as \hat{Γ} (p, q).

To train \hat{Γ}ᵢ(p, qᵢ; θᵢ) the following dataset is generated. First, a set of workspace points

$${P}_{w} = \{ {p}_{1}^{w} , … , {p}_{{N}_{w}}^{w} \}$$

around the sun link. A set of link configurations

$$Q = \{ {q}_{i}^{1} , … , {q}_{i}^{N} \}$$

are uniformly sampled where each

$${q}_{i}^{j}$$

is sampled from the valid configuration space defined by the cable length limits. Next, given the configuration

$${q}_{i}^{j} ,$$

a set of points

$${P}_{s}^{j} ( {q}_{i}^{j} ) = \{ {p}_{1}^{s} , … {p}_{{N}_{s}}^{s} \}$$

is uniformly sampled on the surface of the link

$${B}_{i} ( {q}_{i}^{j} ) .$$

The Euclidean distance from each workspace point

$${p}_{n}^{w} ∈ {p}_{w}$$

to the link with configuration

$${q}_{i}^{j}$$

is computed by:

$${d}_{j , m} = \begin{matrix}min \\ p ∈ {P}_{s}^{j} ( {q}_{i}^{j} )\end{matrix} ‖ {p}_{m}^{w} - p ‖ .$$

Therefore, for each link configuration

$${q}_{i}^{j}$$

and workspace point

$${P}_{m}^{w} ,$$

a distance target value d_{j,m} is had. The resulting dataset for the i-th link is

$${D}_{i} = \{ ( {q}_{i ,}^{j} {p}_{m}^{w} , {d}_{j , m} ) \} \vert j = 1 , … N , m = 1 , … , {N}_{w} \} ,$$

consisting of triplets of link configurations, workspace points, and distance values.

To rain the local N-CEDF for each link, we define a loss function that encourages the learned distance function \hat{F}ᵢ (p, qᵢ; θᵢ) to match the distances in the dataset Dᵢ while satisfying the Eikonal equation ∥∇ₚ \hat{Γ}ᵢ (p, qᵢ; θᵢ)∥=1 in its domain. To enhance safety in motion planning and control, we include an overestimation loss that penalizes the network when it predicts distances larger than the actual values. This encourages conservative distance estimates, reducing the risk of collisions. The complete loss function for the i-th link is:

$${ℓ}_{i} ( {θ}_{i} ; {D}_{i} ) := {ℓ}_{i}^{D} ( {θ}_{i} ; {D}_{i} ) + {λ}_{E} {ℓ}_{i}^{E} ( {θ}_{i} ; {D}_{i} ) + {λ}_{O} {ℓ}_{i}^{O} ( {θ}_{i} ; {D}_{i} ) ,$$

where

$${ℓ}_{i}^{D}$$

is the distance loss,

$${ℓ}_{i}^{E}$$

is the Eikonal loss

$${ℓ}_{i}^{O}$$

is the overestimation loss, and λ_{E}, λ_{O}>0 are tunable parameters. The distance loss

$${ℓ}_{i}^{D}$$

is:

$${ℓ}_{i}^{D} = ( {θ}_{i} ; {D}_{i} ) := \frac{1}{\vert {D}_{i} \vert} {\sum }_{( {q}_{i} , p , d ) ∈ {D}_{i}} {( {\hat{Γ}}_{i} ( p , {q}_{i} ; {θ}_{i} ) - d )}^{2} ,$$

the Eikonal loss

$${ℓ}_{i}^{E}$$

is defined as:

$${ℓ}_{i}^{E} = ( {θ}_{i} ; {D}_{i} ) := \frac{1}{\vert {D}_{i} \vert} {\sum }_{( {q}_{i} , p , d ) ∈ {D}_{i}} {( ∇ p {\hat{Γ}}_{i} ( p , {q}_{i} ; {θ}_{i} ) - 1 )}^{2} ,$$

the overestimation loss

$${ℓ}_{i}^{O}$$

is defined as:

$${ℓ}_{i}^{O} = ( {θ}_{i} ; {D}_{i} ) := \frac{1}{\vert {D}_{i} \vert} {\sum }_{( {q}_{i} , p , d ) ∈ {D}_{i}} {max ( 0 , {\hat{Γ}}_{i} ( p , {q}_{i} ; {θ}_{i} ) - d )}^{2} .$$

FIGS. 2A and 2B visualize the N-CEDF \hat{Γ}ᵢ(p, qi; θi) for a robot link in two different configurations.

### Safe Motion Planning and Control

In this section, the approach to solve Problem 1, utilizing the learned N-CEDF above is presented. MPPI control, see G. Williams, P. Drews, B. Goldfain, J. M. Rehg, and E. A. Theodorou, “Aggressive driving with model predictive path integral control,” in 2016 IEEE International Conference on Robotics and Automation (ICRA), pp. 1433-1440, IEEE, 2016, incorporated herein by reference, is employed for motion planning and control and discuss the design of a cost function.

### MPPI for a Continuum Robot Control

MPPI is a sampling-based MPC scheme that has gained popularity due to its effectiveness in handling complex systems and its ability to incorporate various objectives. MPPI works by sampling and propagating multiple control sequences (rollouts) around a nominal sequence, and then evaluating a new control sequence as the weighted average of all rollouts, which is used to construct the nominal control sequence for the next iteration.

Herein, MPPI is adapted to perform trajectory planning and control for the continuum robot. At each MPPI iteration, given the current configuration of the robot q°, N sequences are sampled of control inputs Uⁱ=(u^{j,0}, . . . , u^{j,H-1}), j=1, . . . , N, for a horizon H. These control inputs are sampled from a Gaussian distribution centered around a reference control sequence (u⁰, . . . , u^{H-1}), with a predefined covariance matrix Σ. These samples are propagated through the system model to obtain the corresponding configuration sequences Qⱼ=(q^{j,0}, . . . , q^{j,H}). The cost of each state sequence, is then computed using a cost function C(Q^{j}) defined below in Cost Function Design.

The costs are combined using exponential averaging to compute the updated control inputs, for t=0, . . . , H−1,

$${\overline{u}}_{t} = ( 1 - {α}_{u} ) {u}^{t} + \frac{{\sum }_{j = 1}^{N} w ( {Q}^{j} ) {u}^{j , t}}{{\sum }_{j = 1}^{N} w ( {Q}^{j} )}$$

where αᵤ∈(0, 1) is a smoothing parameter, and the weights w(Q^{j}) are defined as

$$w ( {Q}^{j} ) = exp ( - \frac{1}{λ} \tilde{C} ( {Q}^{j} ) {u}^{j , t} ,$$

with λ>0 being a temperature parameter and

$$\tilde{C} ( {Q}^{j} ) = \frac{C ( {Q}^{j} ) - {min}_{j} C ( {Q}^{j} )}{{max}_{j} C ( {Q}^{j} ) - {min}_{j} C ( {Q}^{j} )}$$

being the normalized cost.

The initial reference control sequence for MPPI is set to zero. After each MPPI iteration, only the first control input of the updated control sequence is executed, while the remaining part of the updated control sequence is then used as the reference control sequence for the next iteration.

### Cost Function Design

The cost function C(Q^{j}) plays an important role in guiding the robot's behavior. The environment is assumed is represented as a point cloud P_{obst}={p₁, . . . , p_{Nc}}.

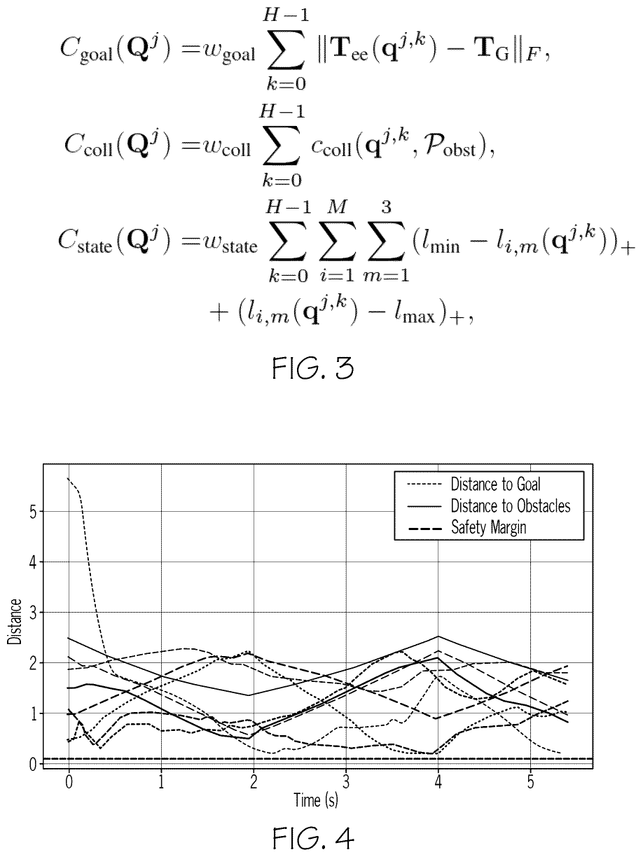

The cost function is composed of three terms: goalreaching cost C_{goal}(Q^{j}), collision avoidance cost C_{coll}(Q^{j}), and state constraint violation cost Cₛₜₐₜₑ(Q^{j}). The goal reaching cost penalizes the distance between the end-effector and the goal. The collision avoidance cost penalizes the robot being too close to obstacles, utilizing the learned NCEDF model and kinematics chains. The state constraint violation cost penalizes the controlled cable lengths exceed their allowable limits. The individual terms are defined as shown in FIG. 3, where ∥|∥_{F} is the Frobenius norm, w_{goal}, w_{coll}, and wₛₜₐₜₑ are tunable weights, l_{i,m}(q^{j,k}) represents the length of the m-th cable in the i-th link at configuration q^{j,k}, and (x)+ denotes max(x, 0).

The collision cost c_{coll} is defined as:

$${c}_{coll} ( {q}^{j , k} , {P}_{obst} ) = \frac{1}{max ( {min}_{p ∈ Pobst} {\hat{Γ}}_{i} ( p , {q}^{j , k} ; θ ) - {δ}_{s} , ϵ )} ,$$

where δₛ is a safety margin, ϵ is a small positive constant, and \hat{Γ}ᵢ(p, q^{j,k}; θ) is the learned N-CEDF value for the robot configuration q^{j,k} and obstacle point p.

### Evaluation

In this section, the performance of the NCEDF model for continuum robot shape modeling is evaluated and its application in motion planning using MPPI. First, the trade-off between the MPPI solver time and the estimation accuracy of various network architectures for the N-CEDF model is investigated. Then, the efficacy of integrating N-CEDF with the MPPI framework for safe and efficient motion planning in dynamic and cluttered environments is shown.

### Simulation Setup

To train the N-CEDF for a link of a continuum robot, we prepare the training data as described in Data Preparation and Loss Function. Each link is assumed to have an inextensible backbone length L=2 m and radius r=0.2 m, with cable length limits lₘᵢₙ=1.6 m and lₘₐₓ=2.4 m. N=250 configurations are uniformly sampled within the cable length limits, N_{w}=323 workspace points within a bounding box, and Nₛ=1600 surface points on the link.

For motion planning and control, we performed simulations with continuum robots with various numbers of links, as described in Problem Formation. All simulations were run on an Ubuntu machine with an Nvidia RTX 4090 GPU and an AMD Ryzen9 7950X3D CPU. The MPPI framework was implemented in JAX (see J. Bradbury, R. Frostig, P. Hawkins, M. J. Johnson, C. Leary, D. Maclaurin, G. Necula, A. Paszke, J. VanderPlas, S. Wanderman-Milne, and Q. Zhang, “JAX: composable transformations of Python+NumPy programs,” 2018 incorporated herein by reference) using N=800 rollouts at each iteration, with an action sampling covariance Σ=0.051 and the temperature parameter λ=0.02. The prediction horizon was set to H=20 with frequency of 20 Hz. The cost weights were set as follows: w_{coll}=1.1, wₛₜₐₜₑ=50.0, and w_{goal}=12.0. The safety margin was δₛ=0.05 m.

Real-time motion planning and control require a balance between the MPPI solver time per step and the estimation accuracy of the N-CEDF model. The performance of different neural network architectures is evaluated by varying the number of layers (2, 3, 4, 5) and the number of neurons per hidden layer (16, 24, 32). For each network configuration, softplus activations were used, and the loss function was optimized using the Adam optimizer (see D. P. Kingma and J. Ba, “Adam: A method for stochastic optimization,” arXiv preprint: 1412.6980, 2015 incorporated by reference herein) with a learning rate of 0.003. The mini-batch size was 256, with λ_{E}=0.05 and λ_{O}=2.0. All configurations were trained for 100 epochs.

To assess the estimation accuracy, a validation dataset Dᵥₐₗ was prepared, constructed similarly to the training dataset described in Data Preparation and Loss Function. The Mean Absolute Error (MAE) and Root Mean Squared Error (RMSE) between predicted and ground-truth distance values are reported. Additionally, the Mean Overestimation Error (MOE) to evaluate the network's tendency to overestimate distances is introduced:

$$\frac{1}{\vert {D}_{val} \vert} max ( 0 , {\hat{Γ}}_{i} ( {p}_{i} , {q}^{j} ) - {d}_{i , j} ) ,$$

where d_{i,j} is the groundtruth distance between point pᵢ and robot configuration qᵢ, and \hat{Γ}ᵢ(pᵢ, q^{j}) is the N-CEDF predicted distance.

The MPPI solver time was evaluated on a 4-link robot in an environment represented by 500 points, serving as observations of the obstacle surfaces. The solver time includes neural network inference, forward kinematics computation, and sampling and weighted averaging of control sequences.

Table I represents the network inference time, MPPI solver time per step, validation error, and distance overestimation for each network configuration. The network depth primarily influences the network inference time, while the MPPI solver time depends on both depth and width, as MPPI requires loading multiple networks onto the GPU for parallel computation. The 4-layer network with 16 neurons per layer achieves a low estimation error (MAE=0.017 m, RMSE=0.024 m) and a small distance overestimation error of 0.002 m while maintaining a competitive MPPI solver time of 0.0331 seconds, providing a balance between accuracy and computational efficiency for real-time control tasks.

TABLE 1
Network inference time, MPPI solver time, and validation
errors for different neural network configurations.

| Network | Inference (ms) | MPPI (s) | MAE & RMSE & MOE (m) |
|---|---|---|---|
| 2, 16 | 0.0136 | 0.0156 | 0.126 & 0.167 & 0.037 |
| 2, 24 | 0.0140 | 0.0205 | 0.105 & 0.137 & 0.023 |
| 2, 32 | 0.0139 | 0.0234 | 0.089 & 0.116 & 0.014 |
| 3, 16 | 0.0179 | 0.0241 | 0.040 & 0.054 & 0.009 |
| 3, 24 | 0.0181 | 0.0337 | 0.033 & 0.044 & 0.006 |
| 3, 32 | 0.0178 | 0.0415 | 0.026 & 0.037 & 0.004 |
| 4, 16 | 0.0218 | 0.0331 | 0.017 & 0.024 & 0.002 |
| 4, 24 | 0.0218 | 0.0471 | 0.017 & 0.025 & 0.002 |
| 4, 32 | 0.0220 | 0.0596 | 0.016 & 0.024 & 0.002 |
| 5, 16 | 0.0257 | 0.0422 | 0.015 & 0.020 & 0.001 |
| 5, 24 | 0.0264 | 0.0603 | 0.014 & 0.020 & 0.001 |
| 5, 32 | 0.0262 | 0.0772 | 0.013 & 0.018 & 0.001 |

To assess the impact of the overestimation loss on the network training, a 4-layer network was trained with 16 neurons per layer with and without this loss component. As shown in Table II, incorporating the loss significantly reduces the MOE while maintaining comparable MAE and RMSE. These results show the importance of the overestimation loss in avoiding distance overestimation, which can be crucial for downstream tasks like safe motion planning and control.

TABLE II
Comparison of MAE, RMSE, and MOE for a 4-layer, 16-neuron
network, trained with and without the overestimation loss.

| Training Configuration | MAE (m) | RSME (m) | MOE (m) |
|---|---|---|---|
| Without Overestimation Loss | 0.018 | 0.024 | 0.011 |
| With Overestimation Loss | 0.017 | 0.024 | 0.002 |

### Navigating Dynamic Environments

Next, the performance of the approach herein is evaluated in randomly generated dynamic environments (FIG. 1B). The environment contains 8 randomly placed spherical obstacles with unknown velocities v_{obs}∈ [symbol] , where ∥v_{obs}∥≤\sqrt{3}. FIG. 4 demonstrates the robot's successful navigation towards the goal while maintaining a safe distance from obstacles. At around t=3.7 seconds, two obstacles approach the robot, triggering a defensive maneuver to preserve the safety margin. During this maneuver, the robot temporarily deviates from its goal-directed path to avoid the obstacles. Once the obstacles are at a safe distance, the robot resumes its motion and successfully reaches the goal.

To further validate the effectiveness of the learned NCEDF representation, a quantitative comparison was conducted between different robot shape representation approaches: (1) using the learned N-CEDF, (2) abstracting the robot shape as spheres, and (3) modeling the robot shape as a point cloud with P points. 1000 environments were randomly generated and ran MPPI with each robot shape representation approach.

As shown in Table III, the learned N-CEDF achieves the highest success rate of 0.986 with an MPPI solver time of only 0.006 s, offering the best overall balance between accuracy and efficiency. In contrast, the sphere-based representation, while being the fastest with a solver time of 0.005 s, suffers from the highest stuck rate of 0.123. This indicates that the sphere abstraction results in an overly conservative shape representation. On the other hand, using a point cloud representation with 1000 points improves the stuck rate to 0.006 but increases the collision rate to 0.052 and the solver time to 0.062 s. Increasing the point cloud resolution to 5000 points reduces the collision rate to 0.008, however, this comes at the cost of a significantly longer MPPI solver time of 0.284 s.

TABLE III
Comparison of robot shape representation approaches. Success, Collision,
and Stuck rates are reported, along with MPPI solver time.

| Shape | Success | Collision | Stuck | MPPI Time (s) |
|---|---|---|---|---|
| N-CEDF | 0.986 | 0.006 | 0.008 | 0.006 |
| Spheres | 0.872 | 0.005 | 0.005 | 0.005 |
| P-Cloud (1000) | 0.942 | 0.052 | 0.052 | 0.062 |
| P-Cloud (5000) | 0.984 | 0.008 | 0.008 | 0.284 |

Navigating with Point-Cloud Data

In this section, the performance of the N-CEDF MPPI approach is evaluated in navigating continuum robots through a cluttered environment (FIG. 4). Simulations were conducted with continuum robots of 4, 5, and 7 links, to assess the scalability of the method. It should be noted that continuum robots of any finite number of links may be used. In all simulations, the environment is represented as point clouds with 500 points, sampled on the surfaces of the static and dynamic obstacles.

Table IV presents the computational performance of our approach. The MPPI solver time increases linearly with the number of links, which demonstrates the scalability of our method to continuum robots with various numbers of links. On the other band, the time step needed to reach the goal decreases as the number of links increases, suggesting that the additional degrees of freedom allow for more efficient navigation through cluttered spaces.

TABLE IV
Mean and standard derivation of MPPI solver time
per step and time step needed for continuum
robots with various links to reach the goal.

| Num of Links | MPPI Solver Time (s) | Reaching Time Step |
|---|---|---|
| 4 | 0.0331 ± 0.0005 | 158 |
| 5 | 0.0419 ± 0.0008 | 82 |
| 7 | 0.0607 ± 0.0006 | 43 |

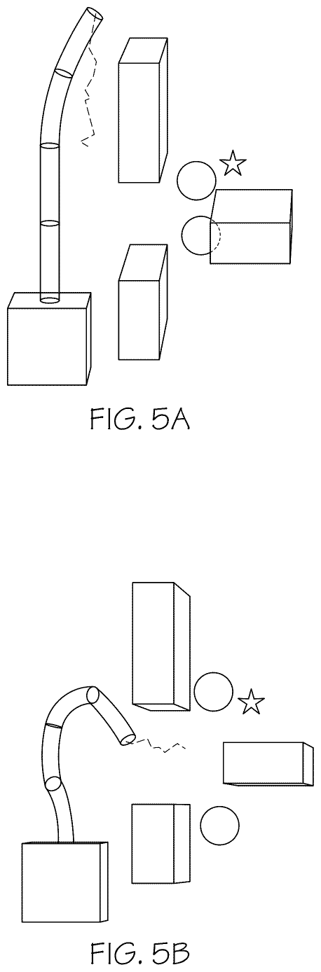

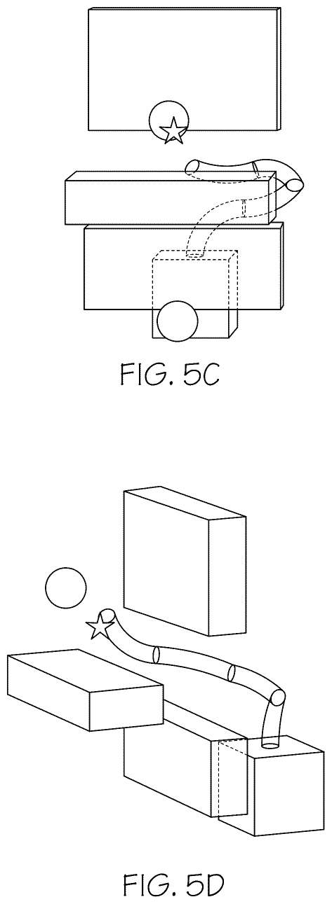

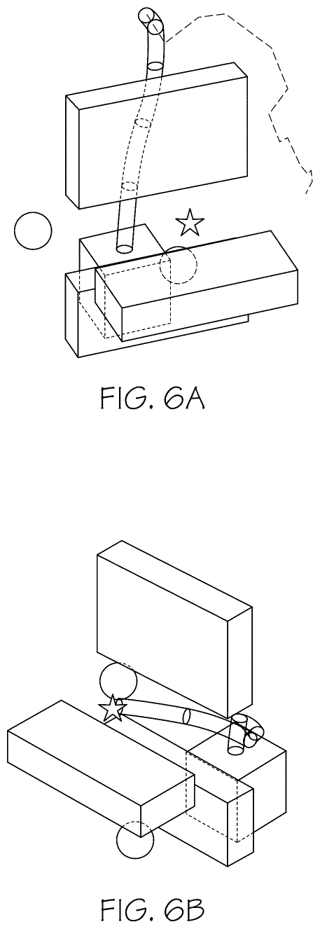

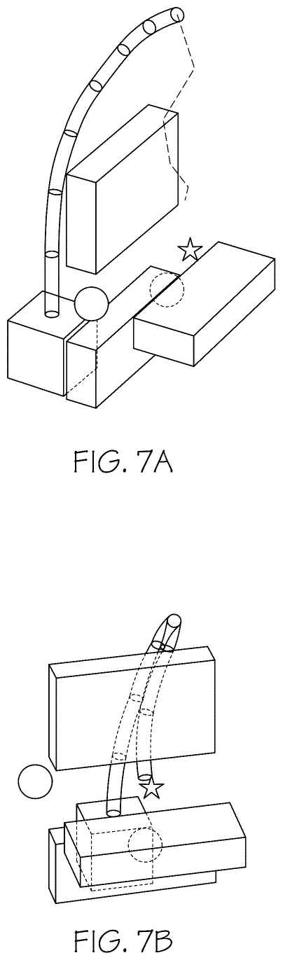

FIGS. SA-7B illustrate the navigation trajectories for 4-, 5-, and 7-link continuum robots, respectively. For the 4-link robot (FIGS. 5A-5D), it can be observed that the robot makes a large detour towards the goal while avoiding obstacles. The 5-link robot (FIGS. 6A and 6B) demonstrates increased maneuverability, allowing it to navigate through other trajectories. The 7-link robot (FIGS. 7A and 7B) exhibits a direct maneuver, leveraging its additional links to reach the goal more efficiently.

In all cases, the proposed N-CEDF MPPI framework generates efficient and safe motion planning and control strategies for the continuum robots. Besides, the ability to scale to robots with different numbers of links without significant computational overhead highlights the potential of the method described herein for a wide range of continuum robot applications.

In this disclosure, a novel method for modeling the shape of continuum robots using Neural Configuration Euclidean Distance Functions (N-CEDF) is introduced. By learning separate distance functions for each link and combining them through the kinematic chain, the N-CEDF efficiently and accurately represents the robot's geometry. The N-CEDF representation is integrated with an MPPI controller for safe motion planning in dynamic and cluttered environments. Extensive simulations demonstrate the effectiveness of the approach in enabling real-time navigation of continuum robots with various numbers of links, relying solely on point cloud observations.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computer-implemented method of planning motion of a continuum robot in a dynamic environment, the method comprising:
training a neural configuration Euclidean distance function (N-CEDF) using training data and a neural network for learning a geometry of each link of the continuum robot and determining a distance field for each link providing a learned N-CEDF;
integrating the learned (N-CEDF) into a Sampling-Based Path or Motion Planning algorithm (SBMP) saved in memory of the computer to generate an N-CEDF SBMP framework;
employing the N-CEDF SBMP framework for motion planning of the continuum robot for determining a planned trajectory in the dynamic environment.

2. The method of claim 1 further comprising moving the continuum robot according to the planned trajectory.

3. The method of claim 1 further comprising simulating movement of the continuum robot according to the planned trajectory in the dynamic environment on the computer.

4. The method of claim 1, wherein the continuum robot is cable-driven or pneumatic actuator driven.

5. The method of claim 4, wherein each link of the continuum robot comprises a flexible, inextensible backbone.

6. The method of claim 4, wherein the continuum robot comprises at least four links.

7. The method of claim 1 further comprising the computer modeling a shape of the continuum robot in the dynamic environment.

8. The method of claim 1 further comprising driving an end-effector of the continuum robot to a goal.

9. The method of claim 8, wherein the step of driving the end-effector of the continuum robot to the goal comprises the planned trajectory maintaining a distance from obstacles in the dynamic environment.

10. A computer-implemented method of planning motion of a continuum robot in a dynamic environment, the method comprising:
modeling a shape of the continuum robot in a dynamic environment using a neural configuration Euclidean distance function (N-CEDF), where the N-CEDF encoding a geometry of each link of the continuum robot using a neural network;
integrating the neural configuration Euclidean distance function (N-CEDF) into a Sampling-Based Path or Motion Planning algorithm (SBMP) saved in memory of the computer to generate an N-CEDF SBMP framework; and
determining a planned trajectory for the continuum robot in the dynamic environment using the N-CEDF SBMP framework.

11. The method of claim 10 further comprising moving the continuum robot according to the planned trajectory.

12. The method of claim 10 further comprising simulating movement of the continuum robot according to the planned trajectory in a simulated environment on the computer.

13. The method of claim 10, wherein the continuum robot is cable-driven or pneumatic actuator driven.

14. The method of claim 13, wherein each link of the continuum robot comprises a flexible, inextensible backbone.

15. The method of claim 13, wherein the continuum robot comprises at least four links.

16. The method of claim 10 further comprising training the N-CEDF using training data and the neural network for learning a geometry of each link of the continuum robot and determining a distance field for each link.

17. The method of claim 16 further comprising preparing training data for training the N-CEDF.

18. The method of claim 10 further comprising driving an end-effector of the continuum robot to a goal.

19. The method of claim 18, wherein the step of driving the end-effector of the continuum robot to the goal comprises the planned trajectory maintaining a distance from obstacles in the dynamic environment.

20. The method of claim 10 further comprising evaluating performance of the N-CEDF SBMP framework in the dynamic environment.
